(19) United States
(12) Patent Application Publication
(10) Pub. No.: US 2002/0019709 A1
(43) Pub. Date: Feb. 14, 2002

(54) System for controlling operation of a sink

(76) Inventor: Noel B. Segal, Rockville, MD (US)

Correspondence Address: Finnegan, Henderson, Farabow,, Garrett & Dunner, L.L.P., 1300 I Street, N.W., Washington, DC, 20005-3315, US

(21) Appl. No.: 09/812,772

(22) Filed: Mar. 15, 2001

Related U.S. Application Data
(63) Continuation-in-part of application No. 09/027,902, filed on Feb. 23, 1998, now Pat. No. 6,236,953.
Application No. 09/027,902 is a continuation-in-part of application No. 08/603,418, filed on Feb. 20, 1996, now Pat. No. 5,793,653.
Application No. 08/603,418 is a continuation-in-part of application No. 08/300,184, filed on Sep. 2, 1994, now abandoned.
Application No. 08/300,184 is a continuation-in-part of application No. 08/273,872, filed on Jul. 12, 1994, now abandoned.

(51) Int. Cl. G01F 1/00; G01F 7/00; G06F 19/00

(52) U.S. Cl. 702/45

(57) ABSTRACT

A system for controlling operation of a sink may include a valving device adapted to be coupled to plumbing of the sink to selectively allow water to flow into a basin of the sink. The valving device can be configured to be actuated in response to a wireless control signal. The system may also include a valve controller for controlling operation of the valving device. The valve controller may be configured to provide the wireless control signal to actuate the valving device. Also provided are systems for monitoring and controlling operation of a sink, and methods of controlling operation of a sink.

### PRIOR APPLICATIONS

The present application is a continuation-in-part of U.S. application Ser. No. 091027,092, filed Feb. 23, 1998 (pending), which is a continuation-in-part of U.S. application Ser. No. 08/603,418, filed Feb. 20, 1996 (now U.S. Pat. No. 5,793,653 ), which is a continuation-in-part of U.S. application Ser. No. 08/273,872, filed Jul. 12, 1994 (abandoned), and U.S. application Ser. No. 08/300,184, filed Sep. 2, 1994 (abandoned), the disclosure of all of which are incorporated herein by reference.

### BACKGROUND OF THE INVENTION

The present invention is directed to a system for controlling operation of a sink. More particularly, the present invention is directed to a system for controlling operation of a sink including a valving device and a valve controller The present invention also relates to a system for monitoring usage of a sink and treating water supplied to the sink, and a method of controlling a sink.

1. Field of the Invention

In many industries, particularly those relating to the processing and preparation of food, contamination of the food product by workers can be a major public health threat. Government health inspectors and industry management have therefore engaged in efforts to require workers to wash their hands before handling food products, and after their hands may have come into contact with any substance that could contaminate the food product.

The U.S. Food and Drug Administration's Food Code provides guidelines for preparing food and preventing food-borne illness. Retail outlets such as restaurants, grocery stores, and other institutions, such as nursing homes, are subject to the Food Code. The Food Code specifies that certain employees must periodically (e.g., every thirty minutes) follow a defined cleaning procedure (e.g., clean hands and exposed portions of arms for at least twenty seconds). (See, e.g., Food Code, § 2-301.12). The Food Code also specifies that employees must follow a more rigorous cleaning procedure after using the bathroom. (See, e.g., Food Code, § 2-301.13).

In addition to requiring employees to wash their hands, the Food Code requires IQ employers to monitor employee hand washing. For example, the Food Code requires implementation of a Hazard Analysis Critical Control Point Plan (HACCP Plan), which is to be monitored by a “person in charge.” An HACCP Plan must include a method of monitoring and a frequency of monitoring and controlling critical points, a method and a frequency to routinely verify that employees are following standard operating procedures and monitoring critical control points, and a system for maintaining records to demonstrate that the HACCP Plan is properly operated and managed. (See, e.g., Food Code, § 8-201.14).

Local, state, and federal regulators use the Food Code as a model to help develop or update their own food safety rules and to be consistent with national food regulatory policy. Also, many of the over one million retail food establishments attempt to apply Food Code provisions to their own operations, although the Food Code is neither federal law nor federal regulation and does not preempt state or local laws.

Despite such extensive efforts to ensure that proper hand washing is performed, more than a quarter of all food-borne illnesses (6,000,000 reported cases, an estimated 81,000,000 unreported cases, and 9,000 deaths in 1992) are believed to be related in some respect to improper hand washing. Similar concerns exist in the health care industry, where improper hand washing is believed to be related to over 500,000 hospital-related (nosocomial) infections each year.

The equipment used in the preparation and service of food, which affects the quality and quantity of the food prepared, is another aspect of the food industry that can benefit from increased monitoring (e.g., increased safety and efficiency).

Other aspects of the food industry outside of those relating to the processing and preparation of food can benefit from structured monitoring. For example, monitoring of employees, chemicals, testing equipment, utilities metering devices, smoke detection systems, and laundry/drying systems are a few examples of items that can benefit from monitoring to thereby increase efficiency and user compliance with predetermined operating parameters.

In light of the foregoing, there is a need in the art for an improved system and method for controlling operation of a sink.

### BRIEF SUMMARY OF A FEW ASPECTS OF THE INVENTION

In accordance with the purpose of the invention, as embodied and broadly described herein, the invention includes a system for controlling operation of a sink. The system may include a valving device adapted to be coupled to plumbing of the sink to selectively allow water to flow into a basin of the sink. The valving device can be configured to be actuated in response to a wireless control signal. The system may also include a valve controller for controlling operation of the valving device. The valve controller may be configured to provide the wireless control signal to actuate the valving device.

In an aspect, the invention may include a system for monitoring and controlling operation of a sink. The system may include an activation device for acknowledging operators of the sink, a timing device for determining time of use data, and a completion input device for generating wash completion data when operators have completed use of the sink. The system may also include a memory storage device for storing operator data sets and predetermined frequency of use parameters for operators of the sink. The operator data sets may include operator acknowledgment data, time of use data, and wash completion data. The system may further include a compliance controller coupled to the memory storage device. The compliance controller may be configured to determine if operators are in compliance with a predetermined sink use regimen by comparing the predetermined frequency of use parameters to the operator data sets. The compliance controller may optionally generate a non-compliance signal when an operator is no longer in compliance with the predetermined frequency of use parameter for the operator. The system may additionally include the valving device described above, and the compliance controller may be adapted to provide the wireless control signal to actuate the valving device.

In another aspect, the invention may include a system for monitoring usage of a sink and treating water supplied to the sink. The system may include a monitoring device configured to monitor usage of the sink. For example, in an embodiment, the monitoring device may include one or more of the features described above. The system may also include a water treatment device adapted to couple to plumbing of the sink. The water treatment device could optionally include at least one of an ultrasonic generator for generating ultrasonic waves in water supplied to the sink, and an electrolyzer configured to decrease a pH level of water supplied to the sink by ionizing water molecules therein.

In a further aspect, the invention may include a method of controlling a sink. The method may include providing a wireless control signal with a valve controller, and receiving the wireless control signal provided by the valve controller with a valving device coupled to plumbing of the sink. The valving device may be adapted to be actuated in response to the wireless control signal to selectively allow water to flow into a basin of the sink. The method may also include actuating the valving device in response to the wireless control signal, allowing water to Flow into the basin of the sink when the valving device is actuated to an open position, and stopping flow of water into is the basin of the sink when the valving device is actuated to a closed position.

It is to be understood that both the foregoing general description and the following detailed description are exemplary and explanatory only, and are not restrictive of the invention as claimed.

### BRIEF DESCRIPTION OF THE DRAWINGS

The accompanying drawings are included to provide a further understanding of the invention and are incorporated in and constitute a part of this specification. The drawings illustrate embodiments of the invention and, together with the description, serve to explain the principles of the invention. In the drawings,

FIG. 1 is a schematic view of an embodiment of the invention coupled to a sink;

FIG. 2 is a diagram showing a controller and various inputs and outputs thereof;

FIG. 3 is a diagram illustrating aspects of the controller of FIG. 2;

FIG. 4 is a schematic view of a second embodiment of the invention;

FIG. 5 is a schematic view of a third embodiment of the invention;

FIG. 6 is a flow chart showing operations relating to evaluation and downloading of data;

FIG. 7 is a flow chart showing operations relating to collection and storage of data;

FIG. 8 is a flow chart showing operations relating to evaluation of compliance with a predetermined use regimen;

FIG. 9 is a schematic view of a first embodiment of a valving device and a valve controller;

FIG. 10 is a schematic view of a second embodiment of a valving device and a valve controller; and

FIG. 11 is a schematic view of a third embodiment of a valving device and a valve controller.

### DETAILED DESCRIPTION OF EMBODIMENTS

Reference will now be made in detail to the embodiments of the invention, examples of which are illustrated in the accompanying drawings. Wherever possible, the same reference numbers are used in the drawings and the description to refer to the same or like parts.

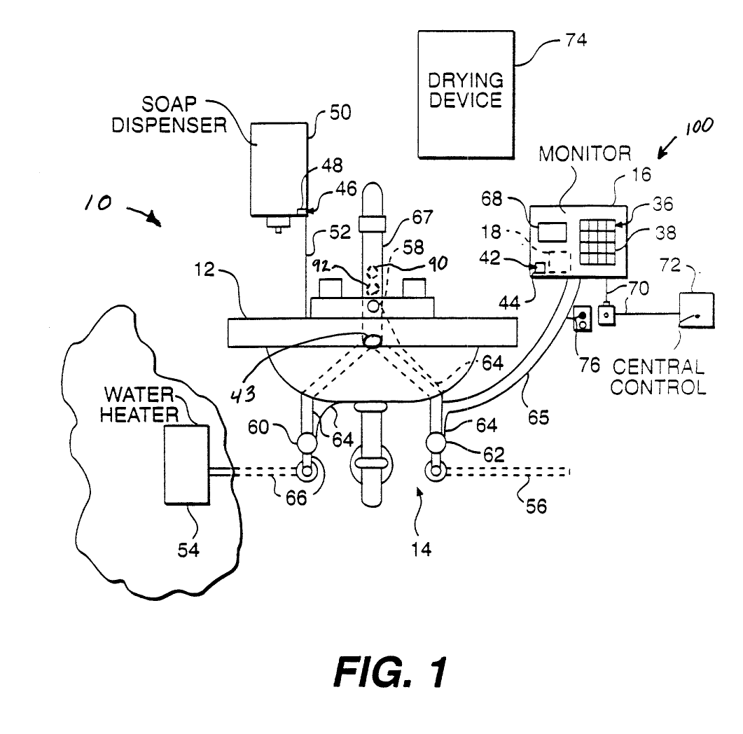

In accordance with the present invention, a system for monitoring and controlling operation of a sink is provided. Referring to FIG. 1, a system 10 may include a monitoring device 100 adapted to monitor and/or control usage of a sink 12 (e.g., a hand sink). The monitoring device 100 may be configured to determine if operators of the sink 12 are in compliance with a predetermined sink use regimen. The sink 12 may include a plumbing assembly 14 providing hot and cold water to the sink 12. The monitoring device 100 may include a monitor box 16 mounted in a location adjacent to the sink 12. The monitor box 16 may house a compliance controller 18, such as a general purpose computer, that controls operation of the system 10 in response to sensed and input data.

Referring to FIG. 3, the compliance controller 18 may include a central processing unit (“CPU”) 20, an electronic clock circuit 22,, a memory 24, and a computer program. The computer program may include an input module 26, a wash sequence module 28, an evaluation module 30, a display module 32, and a communication module 34. Operation of the system 10, as directed by the compliance controller 18 and elements thereof in response to various inputs, will be described in more detail below.

The above-mentioned predetermined sink use regimen may include various aspects found in a cleansing regimen set forth in the FDA Food Code or other government regulations, or may be any other specified regimen, and may have various predetermined parameters. For example, the predetermined cleansing regimen may require each user of the sink to wash his hands in accordance with a specified regimen at given intervals. In an embodiment, the regimen could require a food service employee to wash his hands every thirty minutes.

In another embodiment, the cleansing regimen may require each user of the sink to wash his hands after specified events. For example, the regimen may require a food service user to wash his hands after using a bathroom, or may require a healthcare professional to wash his hands after interacting with a patient.

The cleansing regimen may also specify a wash sequence including various steps, their duration, and their sequential order. For example, a wash sequence may specify wetting for five seconds, soaping and scrubbing for twenty seconds, and rinsing for five seconds. If all of the steps are not completed, the wash could be considered incomplete, and compliance with the regimen not achieved.

Alternately, the cleansing regimen may require different types of washes at different times or after certain events. For example, a more thorough wash may be required periodically or after a bathroom visit.

The system 10 may be capable of monitoring compliance with each of the above variations of a cleansing regimen either separately or simultaneously. One of ordinary skill in the art would appreciate, however, that the present invention is not limited to monitoring only the specified regimen variations discussed herein. Additionally, it should be understood that the present invention is not necessarily limited to monitoring sinks, but may be utilized to monitor compliance with predetermined operating parameters for any system, including but not limited to: employee monitoring systems such as proximity sensing systems, personnel tracking systems, RF and bar code material tracking/personnel tracking systems, systems for controlling the quantity and quality of food, such as refrigeration systems, cooking equipment, appliance washing equipment, ice making equipment, and equipment systems for making frozen food; systems for monitoring use of equipment used for measuring and dispensing materials, such as temperature, pressure, and humidity measurement devices, chemical mixing and dispensing systems, laboratory testing equipment, centrifuge equipment, and gas monitoring systems; and other systems, including but not limited to laundry/drying systems, smoke detection/fire suppression systems, and other metering devices.

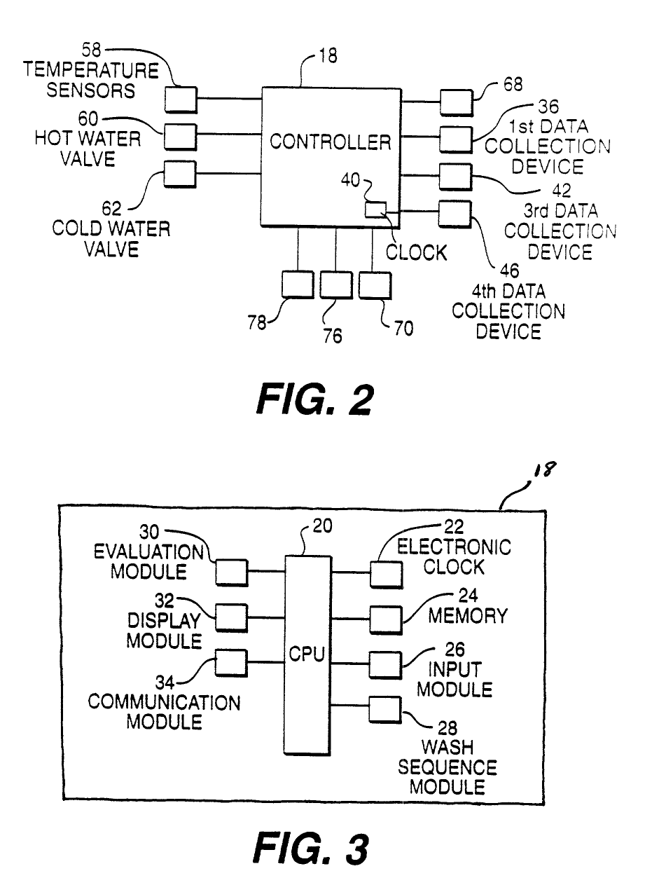

The system 10 may further include an activation device 36 for acknowledging operators or users of the sink 12. For example, the activation device may determine an identity of the operator of the sink 12 during each use for comparison to the predetermined use regimen. As shown in FIGS. 1 and 2, the activation device 36 may be provided on the monitor box 16. Although the activation device 36 is shown in FIG. 1 as being mounted directly on the monitor box 16, the activation device 36 may be disposed elsewhere, and/or could be a component of the sink 12 so as to be convenient to operators. The activation device 36 may determine the identity of an operator of the sink 12 by receiving a code specific to that particular operator, each time that operator uses the sink 12.

In the embodiment shown in FIG. 1, the activation device 36 includes a keypad 38 for use by an operator of the sink 12. The keypad 38 may be capable of receiving codes identifying the operators of the sink 12 and codes identifying different wash types. For example, the keypad 38 may be of a type including an alphanumeric design.

In another embodiment, the activation device 36 may include one or more of a bar code reader, a magnetic strip reader, a retinal scanner, a voice activation/recognition device, and any other suitable data collection or identifying device. If a bar code reader or magnetic strip reader is included as a part of the activation device 36, a card or badge containing a bar code or magnetic strip, respectively, may be issued to each operator. To enable the activation device to acknowledge identity, the operator may place the bar code or magnetic strip in front of or into the reader to allow the activation device 36 to read information from the bar code or magnetic strip. Bar code and magnetic strip readers may reduce the risk of accidental or intentional mis-entry of an operator code by eliminating the need to have an operator manually enter data into a keypad.

The keypad 38 may allow a user to indicate his or her presence at the sink 12 without having to worry about keeping a card or badge handy, and without requiring the employer to stock and program cards or badges for new employees. Direct identity entry into the keypad 38 may also be desirable in environments where the user's hands may become extremely dirty, possibly dirtying a card or badge, thereby interfering with a bar code, fingerprint, or magnetic strip reader.

As explained above, different types of activation devices may be selected within the scope of the present invention, depending on the intended environment and other factors. The present invention is not intended to be limited to use of any of the disclosed activation devices and, accordingly, other suitable alternative devices may be employed.

As shown in FIG. 2, the system 10 may also include a timing device 40 for determining time of use data for each use of the sink 12. The time of use data may be compared to the predetermined use regimen. The compliance controller 18 may include the timing device 40. The timing device 40 may automatically determine the time of use when operators use the sink 12 in order to prevent accidental or intentional entry of the wrong time by the operator.

As shown in FIG. 3, the timing device 40 may include an electronic clock circuit 22 of the compliance controller 18. The electronic clock circuit 22 may continuously generate a time signal during operating hours of the sink. Each time the activation device 36 (shown in FIG. 1) is activated by an operator, time of use data generated by the electronic clock circuit 22 may be stored along with the operator acknowledgment data of the operator in the memory 24 of the controller 18. Thus, when the activation device 36 determines the identity of the operator, the timing device 40 may determine the time of use, and the identity and time of use data may be stored in the memory 24.

The system 10 may also include a completion input device 42 for generating wash completion data when operators have completed use of the sink. The completion of use data can be used for comparison to the predetermined use regimen. As shown in FIG. 1, completion input device 42 may be mounted on the control box 16 adjacent to the sink 12. Alternately, the completion input device 42 could be disposed elsewhere or as a component of the sink 12 or other apparatus, so as to be convenient to the operator. The completion input device 42 may determine whether operators have completed use of the sink 12 without having operators make physical contact with the system 10, thereby maintaining cleanliness of the operators'hands after cleansing.

As shown in FIG. 1, the completion input device 42 may include a photosensor 44 capable of detecting presence of an object in its vicinity by detecting variations in ambient light. Alternately, the completion input device 42 could include an infrared detector, or any other type of noncontacting sensor.

When the completion input device 42 includes a photosensor 44, the photosensor 44 can operate in at least two modes to determine and signal the completion of use of the sink 12. In a first mode of operation, the photosensor 44 may detect the presence of the operator's hand when the hand is within a few inches of the photosensor after completion of a wash sequence (e.g., after the user has soaped, scrubbed, and rinsed his hands), and may generate wash completion data (i.e., a completion signal) in response to the presence of the hand. For example, after the operators complete the wash sequence, they may wave their hands in front of the photosensor 44 to indicate completion. If the operator does not indicate the completion of the wash sequence by waiving a hand in front of the photosensor 44, the photosensor 44 may determine that the operator is not still present and, therefore, may not generate wash completion data, or may generate data indicating a failure to complete the wash.

In a second mode of operation, the photosensor 44 may detect the presence of the operator's body in front of the sink 12 and may generate wash completion data in response thereto. The photosensor 44 can either continuously attempt to detect the presence of the operator throughout the wash sequence, or it can attempt to detect the presence of the operator only after completion of the wash sequence. The sensitivity of the photosensor 44 may be configured to detect objects several feet away. When the photosensor 44 detects the operator in front of the sink 12, either continuously or after completion of the wash sequence, the photosensor may generate wash completion data. If the photosensor 44 detects that the operator is not present in front of the sink 12, either continuously or after completion of the wash cycle, the photosenser may not generate wash completion data, or may generate data indicating a failure to complete the wash.

Optionally, the system 10 may also include at least one auxiliary input device for generating at least one ancillary signal upon actuation of an ancillary device. For example, the system 10 may include an auxiliary input device 46 for detecting cleaning agent use during each use of the sink 12. In the embodiment shown in FIG. 1, the ancillary input device 46 may include a vibration sensor 48 coupled to a cleansing agent dispenser 50 mounted near the sink 12. For example, the vibration sensor 48 may include a piezoelectric sensor for detecting low frequency resonance caused by operators contacting the cleansing agent dispenser 50 to obtain cleansing agent. Alternately, other contact or noncontact sensors could be substituted for the vibration sensor 48. In an embodiment, the ancillary input device 46 may be electronically connected to the compliance controller 18 via wiring 52. The ancillary input device 46 may alternatively be connected to the compliance controller 18 via any suitable communications link. For example, the ancillary input device 46 could be connected to the compliance controller 18 via a radio frequency transmitter/receiver or an infrared transmitter/receiver.

The dispenser 50 may also optionally require the operators to enter identification data prior to dispensing cleansing agent. For example, the system may include a second ancillary input device for determining an identity of the operator of the cleansing agent dispenser 50 during each use for comparison to the use regimen. The second ancillary input device (not shown) could be provided on or near the dispenser 50. In an embodiment, the second ancillary input device could determine the identity of the operator by receiving a code, specific to that particular operator, each time that operator uses the cleansing agent dispenser 50. Alternatively, similar to the activation device, the second ancillary input device could include other configurations, depending on the intended environment and other relevant factors.

As a further option, an additional dispenser (not shown) and a corresponding sensor wired to the compliance controller 18 may be provided. For example, the additional dispenser could dispense a sanitizer (or disinfectant) to be used after final rinsing of the hands. A third ancillary input device could sense whether a user had used the additional dispenser (i.e., sanitizer) after washing, and the wash regimen could require its use. In this embodiment, the memory 24 may also store data regarding use of the ancillary input devices, and the compliance controller 18 could evaluate compliance with the wash regimen, which may require use of the ancillary input devices.

The system 10 may additionally include a drying device 74 for hand drying after cleansing. For example, the drying device 74 could include a paper towel dispenser and/or a hot-air dryer. In this embodiment, the system 10 may further include a fourth ancillary input device configured to sense whether a user has used the drying device 74 after washing, and the wash regimen could require its use. Optionally, the drying device 74 may have a communications link with the cleansing agent dispenser 50. The communications link could include any suitable means including, for example, a radio frequency transmitter/receiver and/or an infrared transmitter/receiver.

The system 10 may also include an electrical power connection 76. Optionally, a battery back-up may be within the monitor box 16 to maintain the memory 24 in case of interruption in electrical power supply.

The system 10 may supply wash materials (e.g., water, soap, disinfectant, etc.) to the sink in a predetermined wash sequence. In an embodiment, the plumbing assembly 14 of the sink 12 may be configured to supply water of a predetermined temperature through a conduit to the basin of the sink 12. The system 10 may also to include a temperature sensor disposed in a water supply line of the plumbing assembly 14 for measuring temperature of water prior to dispensing. For example, when the temperature sensor senses that the temperature of water in the supply line is below a predetermined temperature, the system 10 may cause the water supply line to purge water until the temperature sensor senses that the temperature of the water in the supply line has reached the predetermined temperature.

In an embodiment, the plumbing assembly 14 may include components defining any water flow path defined by the sink 12, as well as other items. For example, the plumbing assembly 14 may include a hot water supply line 66 coupled to a water heater 54, a cold water supply line 56, a mixing union 43 coupled to the hot and cold water lines 54 and 56 for mixing hot and cold water, a faucet 67, a temperature sensor 58, flow control valves 60 and 62, and wiring 64 connecting the sensor 58 and valves 60 and 62 to the controller 18. The plumbing assembly 14 may also include a sewage line for enabling flow of waste water from the basin 13 of the sink 12. The valves 60 and 62 may include a solenoid controlled by the compliance controller 18, and may be opened simultaneously during cleansing to provide mixed hot and cold water at or above the predetermined temperature. Alternately, a single solenoid-controlled valve could be provided downstream of the mixing union 43.

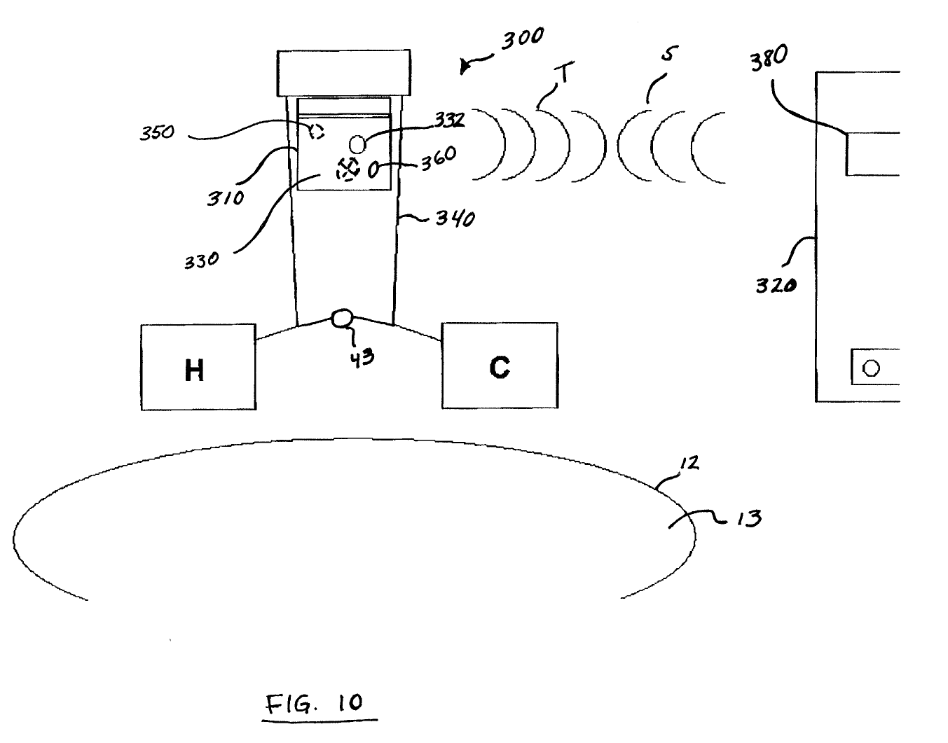

Referring to FIG. 9, in another aspect, the invention may include a system 300 for controlling operation of the sink 12. The system 300 may include a valving device 310 adapted to be coupled to the plumbing assembly 14 of the sink 12 to selectively allow water to flow into the basin 13 of the sink 12. The valving device 310 may be configured to be actuated in response to a wireless control signal S. The system 300 may also include a valve controller 320 for controlling operation of the valving device 310. The valve controller 320 may be configured to provide the wireless control signal S to actuate the valving device 310. For example, the valve controller 320 may include a wireless transmitter 380 adapted to provide the wireless control signal S. The system 300 may be designed so that the valve controller 320 is not connected to the valving device 310 by a wire. The valve controller 320 may be located on a wall adjacent to the sink 12 or, alternatively, may be a portable activation device 370 adapted to be carried by an operator of the sink 12. The wireless control signal S may include one or more of radio waves, infrared waves, ultrasonic waves, luminescence, wireless application protocol (i.e., WAP), and/or Bluetooth. (Bluetooth is a wireless platform standard for networked “appliances.”)

In an embodiment, the valving device 310 includes a valve 330 and a receiving component 332 configured to receive the wireless control signal S. The valve 330 may include a solenoid capable of selectively moving (i.e., actuating) a valve member of the valve 330 between an open position and a close position when the receiving component 332 receives the wireless control signal S, thereby controlling flow of water in the basin 13 of the sink 12. The receiving component 332 may be a conventional receiver capable of receiving radio waves, infrared waves, ultrasonic waves, luminescence, wireless application protocol (i.e., WAP), and/or Bluetooth from the valve controller 320. The valving device 310 may also optionally include a temperature sensor 350 configured to sense temperature of water in the valving device 310 and to provide a temperature signal T, and a wireless transmitter 360 configured to transmit the temperature signal T to a monitoring system, such as the system 10 described above.

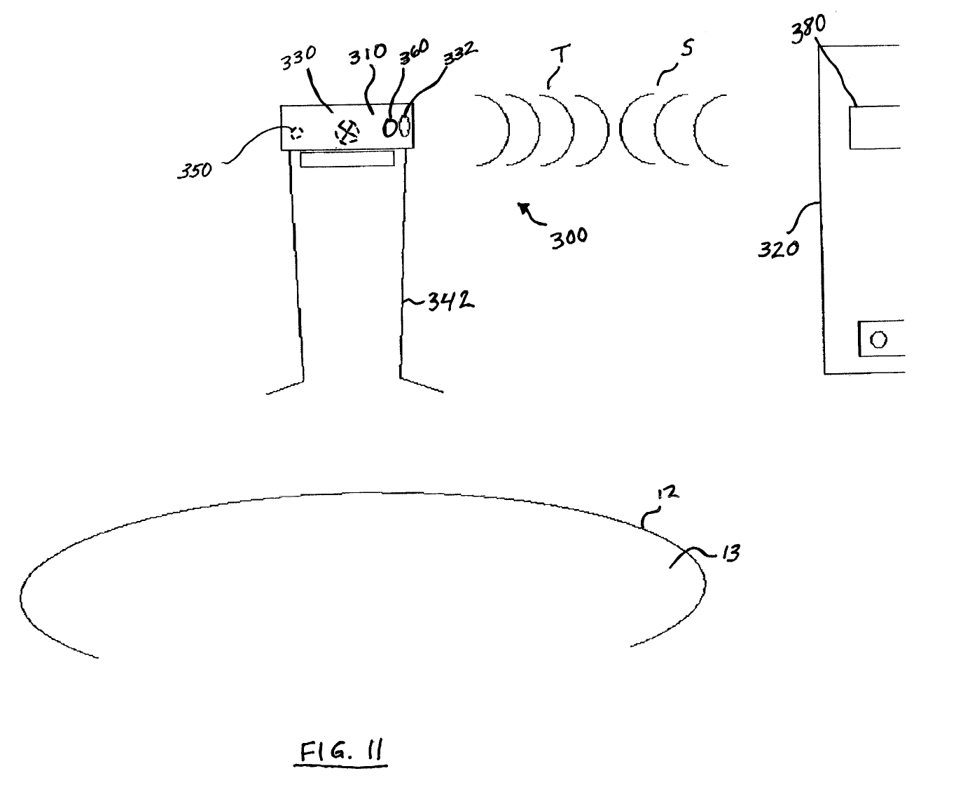

In the embodiment of FIG. 9, the valving device 310 is adapted to be coupled to an outlet end of a faucet 340 of the sink 12. Similarly, FIG. 10 shows an embodiment of the valving device 310 configured to be coupled to an outlet end of the faucet 340 of the sink 12. By designing the valving device 310 to couple to a conventional faucet, the valving device 310 may be used without replacing existing sink components. Alternatively, as shown in FIG. 11, the valving device 310 may be a part of a special faucet 342 designed to replace a conventional faucet of al sink. The design of the special faucet 342 may be more compact than the designs of the embodiments of FIGS. 9 and 10. Each of the embodiments of FIGS. 9-11 may enable control of water supply to the sink without modifying the existing plumbing arrangement.

The system 300 may be used in combination with the system 10 described above for controlling and monitoring operator of the sink 12. For example, the compliance controller 18 may include the valve controller 320. The system 10 could include one or more valving devices 310 coupled to the plumbing assembly 14. For example, the system 10 may include a single valving device 310 located between the mixing union 43 and the end of the faucet 340 for controlling operation of the sink 12, as shown in FIGS. 9-11. Alternatively, the system 10 could include two separate valving devices 310 coupled respectively to the hot and cold water lines of the sink.

In use, the system 300 allows control of operation of the sink 12 by providing a wireless control signal with the valve controller 320. The wireless control signal S is received by the valving device 310. In response to the wireless control signal, the valving device 310 may be actuated. For example, the valving device 310 may be actuated to an open position. When the valving device 310 is actuated to the open position, water may flow into the basin 13 of the sink 12 via the faucet 340 of the plumbing assembly 14. After allowing water to flow for an amount of time, a second wireless signal may be provided with the valve controller 320. In response to the second wireless signal, the valving device 310 may be actuated from the open position to the close position, thereby stopping flow of water into the basin 13 of the sink 12.

In another embodiment, the system 10 may include one or more water treatment devices coupled to the plumbing assembly 14 of the sink 12. For example, the system 10 may include a water dechlorinator located upstream from a mixing union. The system could also include a water ozonator located upstream from the mixing union coupled to one or more of the hot and cold water lines 54, 56. Such a configuration would enable the system 10 to provide a flow of dechlorinated, ozonated water to sink 12.

The system 10 may further include other water treatment devices designed to have a cleansing effect on water supplied to the sink 12. For example, as shown in FIG. 1, the system 10 may include an ultrasonic generator 90 for generating ultrasonic waves in water supplied to the sink 12. The ultrasonic waves generated by the ultrasonic generator 90 may provide a disinfecting treatment to water supplied to the sink 12. In particular, the ultrasonic generator 90 may provide water having active disinfectant qualities both as a bacterial and a viral disruptant. Ultrasonic or “acoustical” energy applied to a medium at certain frequencies may cause cell disrupture and thereby provide a decontaminating effect. Sonochemistry studies by the Department of Applied Physics at Coventry University in the British Midlands have identified “host spots” of local energy that may produce cavitation bubbles within a rarefaction cycle of an ultrasonic wave. When the cavitation bubbles collapse, a surge of energy may be generated capable of destroying biological and organic contaminants in water. The research has been specifically aimed at treatment of chemically polluted water (e.g., polluted water in large-scale, open, waste-treatment basins), improved catalytic destruction of specific pollutants, and remediation of contaminated soil.

Unlike conventional use of ultrasound in large-scale, open, waste-treatment basins, by providing ultrasonic waves in water contained !in plumbing of a sink, the antibacterial properties generated by the ultrasonic waves can be transferred with the flow of water for a duration sufficient to provide disinfection and/or sterilization of hands (and/or other exposed items) of the sink operator, depending upon the duration of exposure and the activity of friction from scrubbing. The ultrasonic generator 90 may be located between an outlet end of a faucet of a sink and a mixing union. Alternately, the ultrasonic generator 90 may be located at the outlet end of the faucet. In still another embodiment, the ultrasonic generator may be in line with the hot water line, the cold water line, or both.

The system 10 may also include an electrolyzer 92 configured to decrease pH level of water supplied to the sink by ionizing water molecules therein. By ionizing water molecules and thereby decreasing the pH level of water supplied to the sink, the electrolyzer 92 may increase acidity of the water, which increases the cleansing properties of the water. Similar to the ultrasonic generator 90, the electrolyzer 92 may be located between an outlet end of the faucet of the sink and a mixing union, at the l8 outlet end of the faucet, or in line with the hot water line, the cold water line, or both. U.S. Pat. No. 5,728,274 discloses an exemplary electrolyzer, the disclosure of which is incorporated herein by reference. A web site of Hoshizaki America, Inc., www.hoshizaki.com/rox.htm, discloses an electrolyzer for cleaning surfaces (referred to as the “ROX-Water Electrolyzer”).

It One or more wash sequences, as described above in connection with the cleansing regimens, may be stored in the memory 24 of the compliance controller 18. The compliance controller 18 may direct the various elements of the plumbing assembly 14 to carry out the wash sequences. For example, the compliance controller 18 could direct the solenoids 60, 62 (or valving device 310) to open for a period of time to wet the operator's hands, direct the solenoids 60, 62 (or valving device 310) to close for a period of time to allow the operator to scrub with a cleansing agent, and then direct the solenoids 60, 62 (or valving device 310) to open again for a period of time to allow the operator to rinse off the cleansing agent. Closing the solenoids 60, 62 (or valving device 310) during the scrubbing period may advantageously conserve water and heating energy, as well as make the operator wait to rinse, thereby likely increasing the actual scrubbing duration of the entire designated scrubbing period.

If a cleansing regimen requires that water of a predetermined (e.g., hot) temperature be provided to the user for effective cleaning,, the compliance controller 18 may direct the solenoids 60, 62 (or valving device 310) to open periodically to purge water in the piping 66 and 67 between the hot water supply line 54 and the sink 12 that may have cooled to below the predetermined temperature. For example, the temperature sensor 58 may detect the temperature of water in the portion of the piping 67 downstream of where the hot and cold water supply lines 54 and 56 merge, and the compliance controller 18 may direct the solenoids 60, 62 (or valving device 310) to open when the detected temperature is below the predetermined temperature. Optionally, only the hot water solenoid 60 may be opened to raise the water temperature at the temperature sensor 58, if desired. Once the temperature sensor 58 senses that the water in the piping 67 has reached or exceeded by a certain amount the predetermined temperature, the compliance controller 18 may direct the solenoids to close.

As explained above and shown in FIGS. 2 and 3, the compliance controller 18 may be configured to evaluate compliance with a predetermined sink use regimen. For example, the CPU 20 and the evaluating module 30 of the compliance controller 18 may determine compliance with the predetermined use regimen by comparing, for example, predetermined frequency of use parameters stored in the memory 24 with time of use data (i.e., electronic clock signals) generated by the electronic clock circuit 22, operator acknowledgment data provided by the activation device 36 (and possibly by the second ancillary input device when present), and wash completion data generated by the completion input device. The operator acknowledgment data, the time of use data, and the wash completion data may be provided to the compliance controller 18 via an input module 26 of the compliance controller 18.

As shown in FIGS. 2 and 3, the CPU 20 of the controller 18 may evaluate compliance with the predetermined use regimen based on wash completion data generated by the completion input device 42 and/or the first ancillary input device 46, by inputting such data to the input module 26 of the compliance controller 18. The CPU 20 and the evaluation module 30 of the compliance controller 18 may determine whether the operator has complied with the predetermined use regimen (e.g., cleansing regimen) based on a comparison to the regimen stored in the memory 24, and then generate compliance data sets for the operators.

In an embodiment, the system 10 may include an access unit to enable access to the predetermined operator parameters (e.g., frequency of use parameters) and/or the compliance data sets stored in the memory 24. The access unit (not shown) may be coupled to a networked device to allow access to the current status of any compliance data set on demand. Access to the access unit may be provided by any suitable means, including but not limited to a keypad, a card swipe device, retinal scanning, facial scanning, or fingerprint scanning, a voice activation system, a bar code device, an infrared receiver/transmitter, an ultrasonic receiver, and/or a radio frequency receiver. Information from compliance data sets may be requested in a variety of ways. For example, the information may be provided from an oifsite data collection system, by facsimile, by a local printer, by cathode ray tube (i.e., CRT), computer, central processing unit, or via the Internet.

The system 10 may also include an access unit connected over a communications link allowing the end-user (i.e., operators) to set, control, and change the operating parameters or request status information for any component device of the system. An operator may gain access to the end-user access unit (not shown) by any suitable means, including but not limited to a keypad, a card swipe device, retinal, facial, or fingerprint scanning, a voice activation system, a bar code device, an infrared receiver/transmitter, an ultrasonic receiver, or a radio frequency receiver.

In an embodiment, the compliance controller 18 generates a non-compliance signal when an operator is no longer in compliance with the predetermined frequency of use parameter for that operator. As shown in FIGS. 1 and 2, a non-compliance warning device may be coupled to the compliance controller 18. The non-compliance warning device may be configured to generate a non-compliance warning when the compliance controller 18 generates a non-compliance signal. For example, the non-compliance warning device could include display element 68 on the monitor box 16 for providing various information to the user. In an embodiment, the display element 68 may be designed to signal a complete or an incomplete wash to the operator. The display element 68 could also flash an operator's identity code and a signal such as “wash due” to alert the operator and others that a particular operator has not complied with the wash regimen (i.e., predetermined wash frequency). The display element 68 could further indicate the identity code entered by the operator, the time of use, and the steps to follow in the wash sequence as the sequence progresses. The display element 68 may be a LCD display, a LED display, or any other suitable display. The CPU 20 and the display module 32 of the controller 18 may direct the display element 68 to display information, based on various determinations made by the elements of the compliance controller 18, as described above.

The system 10 may also include a central control device 72 located remote from the sink 12 and an electronic communication link 70 between the compliance controller 18 and the central control device 72, wherein the CPU 20 directs the memory 24 to periodically download stored data to the central control device 72. As shown in FIG. 1, the communication link 70 allows the compliance controller 18 in the monitor box 16 to communicate with the central control device 72, which could be a general purpose computer located remote from the handsink. When desired, the communication module 34 of the compliance controller 18 can download the data stored in the memory 24 to the central control device 72. A download period may be, for example, a day, a week, a month, etc. Communication via the communication link 70 may be initiated either automatically, according to download period expiration, or manually, when desired, via either the central control device 72 or the CPU 20.

The central control device 72 can include a data processor capable of analyzing all of the data gathered by the system 10 (e.g., operator acknowledgment data, time of use data, wash completion data, compliance data, and any data from ancillary input devices), and determinations made by the CPU 20. Based on analysis by the central control device 72, reports can be prepared listing users, user id's, and corresponding use frequency, type, and completion information. Preparation of reports at the remote central control device location may allow the information to be obtained without requiring maintenance of a printer or the like at the sink location.

The communication link 70 may be any of a number of suitable communication devices. For example, the communication link 70 may include a telephone line with a modem housed in the monitor box 16 to allow communication with the central control unit 72. Alternately, the communication link 70 may include an Internet connection, a local area network, a wide area network, dedicated hardwired link, and/or a wireless system such as radio frequency telemetry or an infrared receiver/transmitter.

Alternately, the communication link 70 may be omitted if, for example, the monitor box 16 is configured to download data via a printer connection to a printer for creating a hard copy of the data, or if data is stored on a disk, CD, or any other type of permanent media, so that the data could be used by the central control unit 72 in the ways described above.

If desired, the central control unit 72 itself may also be omitted, and the sensed and compiled data may be manipulated by the controller 18 in the monitor box 16. Alternately, if desired, the remote central control unit 72 may be replaced by a local general purpose computer equipped to communicate with the monitor box 16.

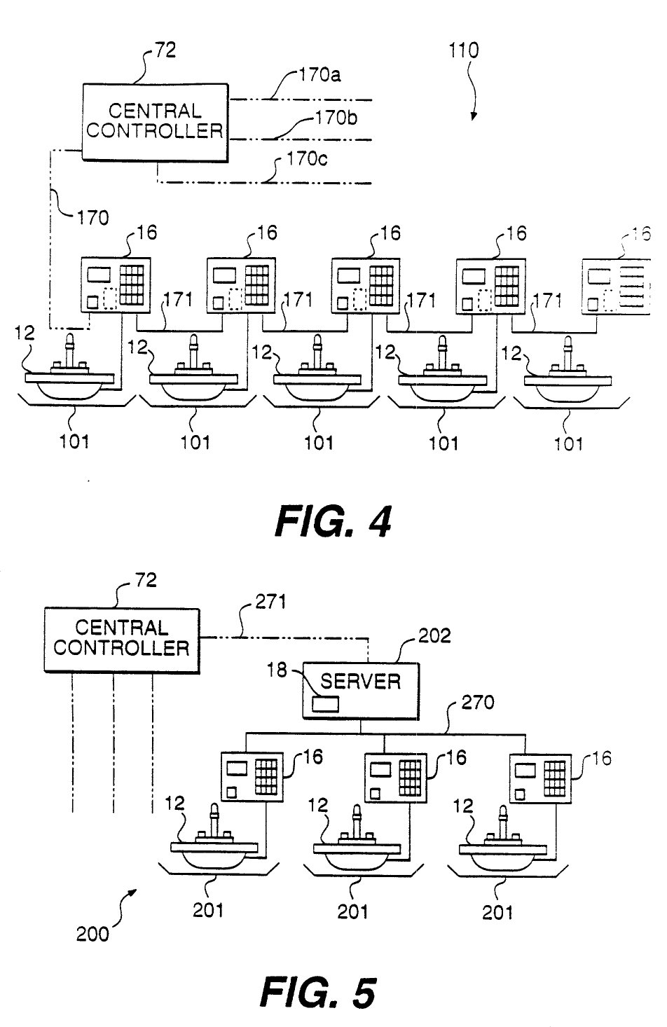

FIGS. 4 and 5 show alternate embodiments of the present invention in which a system 110 may include a plurality of cleansing stations 101. Each cleansing station 101 may include a sink 12, a monitor box 16, and a plumbing assembly. The cleansing stations 101 may include the activation device 36, the timing device 40, the completion input device 42, and optionally the auxiliary input device 46, as described above.

At least one of the cleansing stations 101 may be electronically connected via a communication link 170 to a central control device 72, and all of the cleansing stations 101 may be connected to each other via wiring 171. Alternately, each of the cleansing stations 101 could be connected to the central control device 72 via separate communication links. As shown in FIG. 4, the central control device 72 may be connected to other groups of cleansing stations (not shown) by other communication links 170a-c.

In the embodiment of FIG. 4, the controller of the leftmost cleansing station receives and evaluates data from the devices 36, 40, 42, and 46 of all of the cleansing stations via wiring 171, thereby determining whether the operators have complied with the wash regimen. The cleansing stations 101 may be connected to each other by communication links, such as an Internet connection, a local area network, a wide area network, and/or a dedicated hardwired link, or they may be connected by a wireless system, such as radio frequency telemetry or an infrared receiver/transmitter. The arrangement of FIG. 4 may allow an operator that works in a location having a plurality of cleansing stations to use different cleansing stations over time without having false “wash due” signals being displayed on any of the wash stations not being used.

FIG. 5 shows another system 210 in which a plurality of cleansing stations 201 may be electrically connected by a communication link 270 to a server 202 which, in turn, may be electrically connected by another communication link 271 to a central control device 72, as described above. The server 202 may house the controller 18, so that the data gathering and evaluation can be performed in the server, rather than in one of the individual monitor boxes 16. Otherwise, the arrangement of FIG. 5 operates substantially similar to that of FIG. 4.

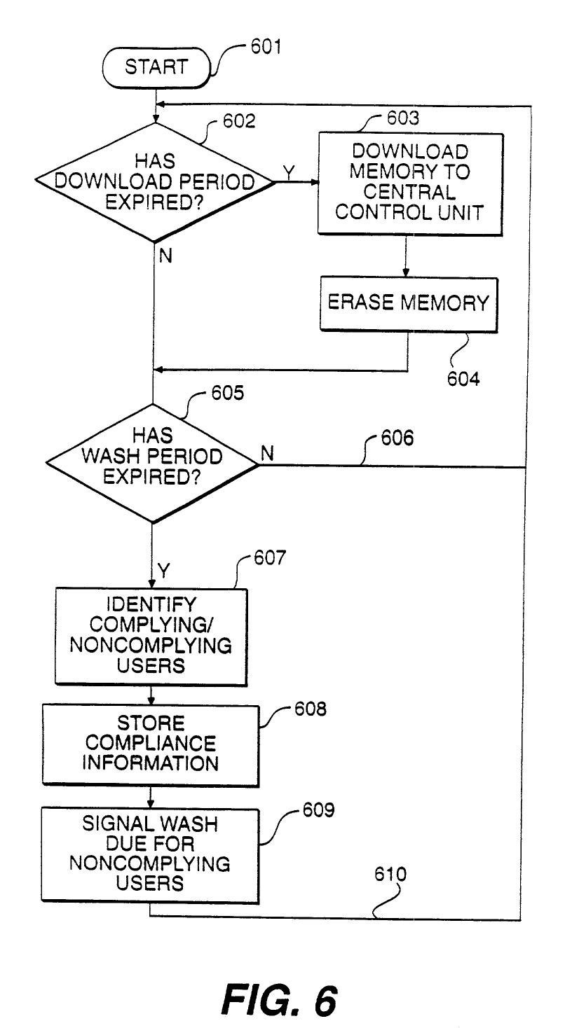

FIGS. 6-8 include flowcharts that further illustrate the operation of the present invention. FIG. 6 shows how the controller controls the downloading of information to the central control device and determines whether to generate wash due signals. Beginning at the “start” (601), assuming that a central control device 72 is employed, the CPU 20 and the evaluation module 30 can determine (602) whether the download period has expired with reference to the electronic clock circuit 22. If the download period has expired (603), the CPU 20 and the communication module 34 may download the memory 24 via the communication link 70 to the central control device 72. The CPU 20 may then cause the memory 22 to be erased (604).

If the download period has not expired, or after the memory is erased, the CPU 20 and the evaluation module 30 may determine (605) whether the wash period (a maximum permissible period between washes dictated by a wash regimen) has expired with reference to the electronic clock circuit 22. If not, the analysis begins again (606).

If the wash period has expired, the CPU 20, evaluation module 30, electronic clock circuit 22, and input module 26 may identify complying and noncomplying users (607). The CPU 20 may then direct the memory 24 to store the compliance information (608). The CPU 20 and the display module 32 can then cause the display element 68 to indicate that noncomplying users have not complied with the cleansing regimen (609). At this point, the analysis begins again (610).

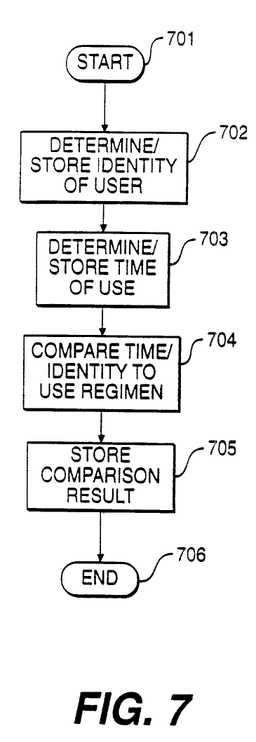

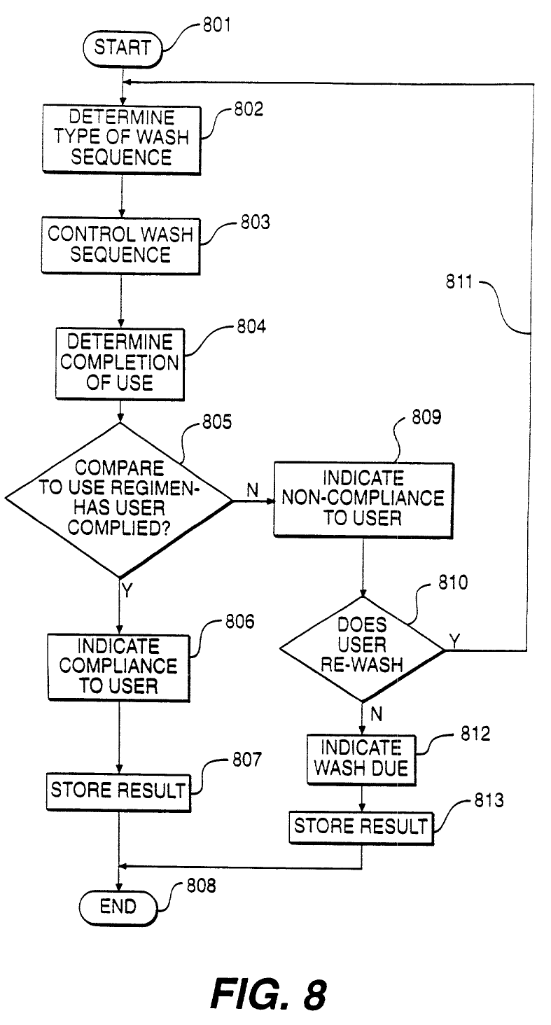

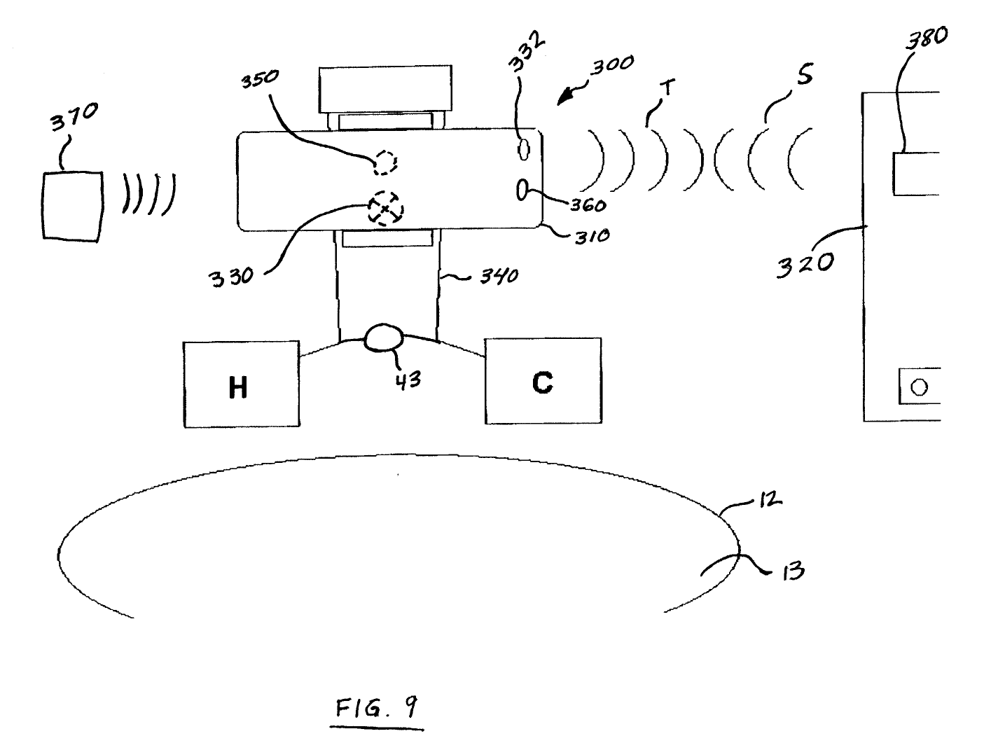

FIG. 7 shows the evaluation of compliance with the cleansing regimen based on determined user identity and time data. Beginning at the “start” (701), the activation device 36 may determine operator acknowledgment data (e.g., the identity of the user), which the CPU 20 and input module 26 direct to be stored in the memory 24 (702). The timing device 40 may determine the time of use data, which the CPU 20 and input module 26 direct to be also stored in the memory 24 (703). The CPU 20 and the evaluation module 30 may then compare the operator acknowledgment and time of use data to the requirements of the cleansing regimen stored in the memory 24 (704). The CPU 20 may direct that the result of the comparison be stored in the memory 24 (705), which ends (706) the analysis.

FIG. 8 shows an exemplary flow chart of evaluation of compliance with the cleansing regimen based on determined completion of use data. Beginning at the “start” (801), the wash sequence may be chosen from the memory 24 by the CPU 20 based on inputs from the operator into the activation device 36 or based on a clock signal output by the electronic clock circuit 22 (802). The CPU 20 and the wash sequence module 28 may then direct the plumbing assembly 14 to provide cleansing supplies in the chosen wash sequence (803). The completion input device 42 and/or the auxiliary input device 46 may then determine a completion of the use by the operator (804). The CPU 20 and the evaluation module 30 may then compare the completion of use data (i.e., wash completion data) to the requirements of the cleansing regimen stored in the memory 24 (805).

If the operator or user has complied with the cleansing regimen, the CPU 20 and the display module 26 may direct the display element 68 to indicate the compliance of the user (806). The CPU 20 may direct that the result of the comparison be stored in the memory 24 (807), which ends (808) the analysis.

If the operator or user has not complied with the cleansing regimen, the CPU 20 and the display module 26 may direct the display element 68 to indicate the lack of compliance of the user (809). The CPU 20 may then determine whether the operator initiates a rewashing (810). If the operator does initiate a rewashing, the wash analysis begins again (811). If the operator does not initiate a rewashing, the CPU 20 and the display module 26 may direct the display element 68 to indicate the lack of compliance with the cleansing regimen to the user (812). The CPU 20 may then direct that the result of the comparison be stored in the memory 24 (813), which also ends (808) the analysis.

It will be apparent to those skilled in the art that various modifications and variations can be made to the structure and methodology of the present invention without departing from the scope or spirit of the invention. In view of the foregoing, it is intended that the present invention covers modifications and variations of this invention, provided that they fall within the scope of the following claims and their equivalents.

What is claimed is:

1. A system for controlling operation of a sink, the system comprising:
a valving device adapted to be coupled to plumbing of the sink to selectively allow water to flow into a basin of the sink, the valving device being configured to be actuated in response to a wireless control signal; and
a valve controller for controlling operation of the valving device, the valve controller being configured to provide the wireless control signal to actuate the valving device.

2. The system of claim 1, wherein the valving device includes a valve and a receiving component, the receiving component being configured to receive the wireless control signal.

3. The system of claim 2, wherein the valving device includes a solenoid configured to actuate the valve when the receiving component receives the wireless control signal.

4. The system of claim 1, wherein the valve controller is not connected to the valving device by a wire.

5. The system of claim 1, wherein the valving device is located between an end of a faucet of the sink and a mixing union for mixing hot and cold water from hot and cold water lines of the plumbing of the sink.

6. The system of claim 1, wherein the valve controller is adapted to be mounted on a wall adjacent to the sink.

7. The system of claim 1, further comprising a portable activation device including the valve controller, said portable activation device being adapted to be carried by an operator of the sink.

8. The system of claim 1, wherein the wireless control signal provided by the valve controller includes at least one of radio waves, infrared waves, ultrasonic waves, luminescence, wireless application protocol, and Bluetooth.

9. The system of claim 1, further comprising a monitoring device configured to monitor usage of the sink.

10. The system of claim 9, wherein the monitoring device includes the valve controller.

11. The system of claim 1, wherein the valving device is adapted to couple to an outlet end of a faucet of the sink.

12. The system of claim 1, wherein the valving device is a part of a faucet of the sink.

13. The system of claim 1, further comprising a water treatment device adapted to couple to the plumbing of the sink, the water treatment device including at least one of an ultrasonic generator for generating ultrasonic waves in water supplied to the sink, and an electrolyzer configured to decrease a pH level of water supplied to the sink by ionizing water molecules therein.

14. The system of claim 13, wherein the water treatment device includes the ultrasonic generator.

15. The system of claim 13, wherein the water treatment device includes the electrolyzer.

16. The system of claim 13, wherein the water treatment device is located between the valving device and an outlet end of a faucet of the sink.

17. The system of claim 10, wherein the valving device includes
a temperature sensor configured to sense temperature of water in the valving device and to provide a temperature signal, and
a wireless transmitter configured to transmit the temperature signal to the monitoring device.

18. A system for monitoring and controlling operation of a sink, the system comprising:
an activation device for acknowledging operators of the sink;
a timing device for determining time of use data;
a completion input device for generating wash completion data when operators have completed use of the sink;
a memory storage device for storing operator data sets and predetermined frequency of use parameters for operators of the sink, the operator data sets including operator acknowledgment data, time of use data, and wash completion data;
a compliance controller coupled to the memory storage device, the compliance controller being configured to determine if operators are in compliance with a predetermined sink use regimen by comparing the predetermined frequency of use parameters to the operator data sets, the compliance controller generating a noncompliance signal when an operator is no longer in compliance with the predetermined frequency of use parameter for the operator; and
a valving device adapted to be coupled to plumbing of the sink to selectively allow water to flow into a basin of the sink, the valving device being configured to be actuated in response to a wireless control signal, wherein the compliance controller is adapted to provide the wireless control signal to actuate the valving device.

19. The system of claim 18, further comprising a non-compliance warning device coupled to the compliance controller, the non-compliance warning device being configured to provide a non-compliance warning when the compliance controller generates a non-compliance signal.

20. A system for monitoring usage of a sink and treating water supplied to the sink, the system comprising:
a monitoring device configured to monitor usage of the sink; and
a water treatment device adapted to couple to plumbing of the sink, the water treatment device including at least one of an ultrasonic generator for generating ultrasonic waves in water supplied to the sink, and an electrolyzer configured to decrease a pH level of water supplied to the sink by ionizing water molecules therein.

21. The system of claim 20, wherein the water treatment device includes the ultrasonic generator.

22. The system of claim 20, wherein the water treatment device includes the electrolyzer.

23. The system of claim 20, wherein the water treatment device is located between an outlet end of a faucet of the sink and a mixing union for mixing hot and cold water from hot and cold water lines of the plumbing of the sink.

24. The system of claim 20, wherein the monitoring device includes
an activation device for acknowledging operators of the sink,
a timing device for determining time of use data,
a completion input device for generating wash completion data when operators have completed use of the sink,
a memory storage device for storing operator data sets and predetermined frequency of use parameters for operators of the sink, the operator data sets including operator acknowledgment data, time of use data, and wash completion data,
a compliance controller coupled to the memory storage device, the compliance controller being configured to determine if operators are in compliance with a predetermined sink use regimen by comparing the predetermined frequency of use parameters to the operator data sets, the compliance controller generating a non-compliance signal when an operator is no longer in compliance with the predetermined frequency of use parameter for the operator, wherein the compliance controller is configured to couple to the plumbing of the sink to control the delivery of water to the sink, and
a non-compliance warning device coupled to the compliance controller, the non-compliance warning device being configured to provide a non-compliance warning when the compliance controller generates a non-compliance signal.

25. A method of controlling a sink, the method comprising:
providing a wireless control signal with a valve controller;
receiving the wireless control signal provided by the valve controller with a valving device coupled to plumbing of the sink, the valving device being adapted to be actuated in response to the wireless control signal to selectively allow water to flow into a basin of the sink;
actuating the valving device in response to the wireless control signal to at least one of an open position and a closed position;
allowing water to flow into the basin of the sink when the valving device is actuated to the open position; and
stopping flow of water into the basin of the sink when the valving device is actuated to the closed position.

26. The method of claim 25, wherein the providing of a wireless control signal includes providing at least one of radio waves, infrared waves, ultrasonic waves, luminescence, wireless application protocol, and Bluetooth.

27. The method of claim 25, wherein the receiving of the wireless control signal includes receiving the wireless control signal with Ea receiving component of the valving device.

28. The method of claim 25, wherein valving device includes a valve and a solenoid, and wherein the actuating of the valving device includes actuating the valve with the solenoid.

29. The method of claim 25, wherein the providing of the wireless control signal includes providing first and second wireless control signals with the valve controller, wherein the receiving of the wireless control signal includes receiving the first and second wireless control signals with the valving device, and wherein the actuating of the valving device includes actuating the valving device to the open position in response to the first wireless control signal to thereby allow water to flow into the basin of the sink, and actuating the valving device to the closed position in response to the second wireless control signal to thereby stop water from flowing into the basin of the sink.

30. The method of claim 25, wherein the valving device includes a valve coupled to an outlet end of a faucet of the sink, and wherein the actuating of the valving device includes actuating the valve.

31. The method of claim 25, wherein the valving device includes a valve that is a part of a faucet of the sink, and wherein the actuating of the valving device includes actuating the valve.

32. The method of claim 25, wherein the valving device includes a valve located between an end of a faucet of the sink and a mixing union for mixing hot and cold water from hot and cold water lines of the plumbing of the sink, and wherein the actuating of the valving device includes actuating the valve.

33. The method of claim 25, wherein a portable activation device includes the valve controller, and wherein the providing of the wireless control signal includes providing the wireless control signal with the portable activation device.

34. The method of claim 25, wherein the valve controller is mounted on a wall adjacent to the sink, and wherein the providing of the wireless control signal includes providing the wireless control signal with the valve controller mounted on the wall.

35. A system for monitoring and controlling operation of a sink, comprising:
the system of claim 1;
a monitoring device configured to monitor usage of the sink; and
a water treatment device adapted to couple to plumbing of the sink, the water treatment device including at least one of an ultrasonic generator for generating ultrasonic waves in water supplied to the sink, and an electrolyzer configured to decrease a pH level of water supplied to the sink by ionizing water molecules therein.
